(19) United States
(12) Patent Application Publication
(10) Pub. No.: US 2026/0153867 A1
(43) Pub. Date: Jun. 4, 2026

(54) CRAWLER VEHICLE AND CONTROL METHOD TO CONTROL SAID CRAWLER VEHICLE

(71) Applicant: PRINOTH S.P.A., Vipiteno (IT)

(72) Inventors: Francesco Salis, Vipiteno (IT); Elia Bontempelli, Vipiteno (IT); Alberto Paoletti, Vipiteno (IT); Martin Kirchmair, Vipiteno (IT); Georg Rautscher, Vipiteno (IT)

(21) Appl. No.: 19/394,441

(22) Filed: Nov. 19, 2025

(30) Foreign Application Priority Data
Nov. 29, 2024 (IT) 102024000027078
Dec. 18, 2024 (IT) 102024000028929

(51) Int. Cl. G05D 1/243; E01H 4/02; G05D 1/622; G05D 101/10; G05D 107/30; G05D 111/10

(52) U.S. Cl. CPC G05D 1/243; G05D 1/637; E01H 4/02; G05D 2101/10; G05D 2107/30; G05D 2111/17

(57) ABSTRACT

A crawler vehicle having a frame; a pair of motorized tracks; a detection device configured to detect data indicative of an environment surrounding the crawler vehicle; and a control system. The control system comprises a processing module configured to process the data detected by the detection device and to identify a position and/or a conformation of reference elements in the environment surrounding the crawler vehicle as a function of the processed data. The control system is configured to perform at least one of the following actions: send to an interface screen information indicative of the identified position and/or the identified conformation of the reference elements; control the advancement of the crawler vehicle in the surrounding environment as a function of the identified position and/or the identified conformation of the reference elements.

### PRIORITY CLAIM

This application claims the benefit of and priority to Italian Patent Application No. 102024000027078, filed on Nov. 29, 2024 and claims the benefit of and priority to Italian Patent Application No. 102024000028929 filed on Dec. 18, 2024, the entire contents of which are each incorporated by reference herein.

### TECHNICAL FIELD

The present disclosure relates to a crawler vehicle, such as a crawler vehicle used for preparing ski runs, and a control method to control the crawler vehicle.

### BACKGROUND

Generally, a crawler type vehicle comprises a frame, a driver's cab, a propulsion system, a pair of motorized tracks, and, in certain instances, working tools.

Crawler vehicles are used to advance along off-road routes for the purpose of transporting goods and/or people and/or to carry out a wide range of different jobs, such as preparing the snowpack of ski runs or cleaning beaches, or for agricultural operations.

However, given the relative complexity of certain crawler vehicles, driving a crawler vehicle is in itself a relatively very difficult and delicate task that must be entrusted to experienced drivers. Moreover, in the environments in which the crawler vehicles operate, any adverse weather conditions and/or the unpredictability of the conformation of the off-road routes make the driving operations of the crawler vehicle even more complex.

### SUMMARY

An aim of the present disclosure is to realize a crawler vehicle that mitigates certain of the drawbacks of certain of the prior art.

In accordance with certain embodiments of the present disclosure, a crawler vehicle is realized, such as a crawler vehicle for preparing ski runs. The crawler vehicle of these embodiments is configured to advance in an operational environment and comprises a frame, a pair of motorized tracks, a detection device configured to detect data indicative of an environment surrounding the crawler vehicle, and a control system, which is in communication with the detection device. The control system comprises a processing module configured to process the data detected by the detection device and to identify a position and/or a conformation of reference elements in the environment surrounding the crawler vehicle as a function of the processed data. The control system is configured to perform at least one of: sending to an interface screen information indicative of the identified position and/or the identified conformation of the reference elements to enable a display of the information on the interface screen; sending to a remote monitoring system information indicative of the identified position and/or the identified conformation of the reference elements; controlling the advancement of the crawler vehicle in the surrounding environment as a function of the identified position and/or the identified conformation of the reference elements; and/or interrupting the advancement of the crawler vehicle in the surrounding environment as a function of the identified position and/or the identified conformation of the reference elements. In accordance with these embodiments, it is possible to autonomously control the advancement of the crawler vehicle in the operational environment or at least assist a driver of the crawler vehicle in driving.

In the event that the control system autonomously controls the advancement of the crawler vehicle, based on the detection of the position and conformation of the reference elements, it is possible to avoid any obstacles along the path of the crawler vehicle.

In certain additional or alternative embodiments, based on the display of the information on the reference elements, it is possible to simplify the driving operations of the crawler vehicle so as to enable the crawler vehicle to be driven even by a driver with relatively little experience.

In certain additional embodiments, it is possible to control the advancement of the crawler vehicle even remotely, without the need to keep the driver aboard the crawler vehicle.

A further aim of the present disclosure is to realize a control method to control a crawler vehicle that mitigates certain of the drawbacks of certain of the prior art.

In accordance with certain embodiments of the present disclosure, a control method to control a crawler vehicle is realized. The control method of these embodiments comprising detecting data indicative of an environment surrounding the crawler vehicle, and processing the detected data and identifying a position and/or a conformation of reference elements in the environment surrounding the crawler vehicle as a function of the processed data. The control method also comprises performing at least one of: sending to an interface screen information indicative of the identified position and/or the identified conformation of the reference elements to enable a display of the information on the interface screen, sending to a remote monitoring system information indicative of the identified position and/or the identified conformation of the reference elements, controlling the advancement of the crawler vehicle in the surrounding environment as a function of the identified position and/or the identified conformation of the reference elements, and/or interrupting the advancement of the crawler vehicle in the surrounding environment as a function of the identified position and/or the identified conformation of the reference elements. In accordance with these embodiments, it is possible to automatically identify the position and conformation of reference elements, such as obstacles or edges of a path, to define an area that can be travelled by the crawler vehicle. In this way, the control system can autonomously control the advancement of the crawler vehicle in the area that can be travelled or can assist a driver of the crawler vehicle in driving.

### BRIEF DESCRIPTION OF THE DRAWINGS

Further characteristics and advantages of the present disclosure are defined in the dependent claims and will become clear from the following description of non-limiting examples of embodiment thereof, with reference to the figures of the attached drawings, wherein:

FIG. 1 is a view in side elevation, with parts removed for clarity and schematised parts, of a crawler vehicle made in accordance with the present disclosure;

FIG. 2 is a block diagram of a detail of the crawler vehicle of FIG. 1;

FIG. 3 is a flowchart of a method to control the crawler vehicle of FIG. 1; and

FIGS. 4 and 5 are respective examples of processed digital images of a control system of the crawler vehicle of FIG. 1.

### DETAILED DESCRIPTION

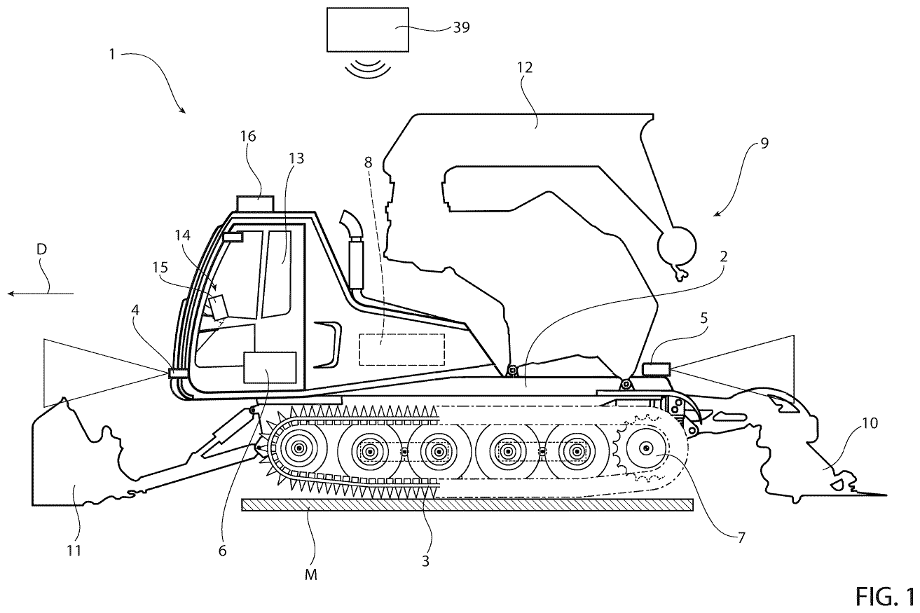

With reference to FIGS. 1, 1 denotes as a whole a crawler vehicle, which in the case shown is used for preparing a snowpack M of ski runs. In certain embodiments, the crawler vehicle 1 is a snow groomer. In more detail, the crawler vehicle 1 is used for preparing one or more of downhill ski runs, cross-country ski runs, ski-jumping ramps, half-pipe ski runs, snow-parks, and/or snowmobile tracks.

In accordance with certain embodiments, the crawler vehicle 1 can be used for the maintenance of sandy areas, such as beaches, or for agricultural operations, such as one or more of harvesting agricultural products, handling of agricultural products, forage silage, bagasse harvesting and/or bagasse handling.

In addition and in accordance with certain embodiments (not shown in the figures), the crawler vehicle 1 can comprise a shredder such as positioned at the front of the crawler vehicle 1 and can be used for shredding vegetation.

In accordance with certain embodiments of the present disclosure, the crawler vehicle 1 is configured to advance in an operational environment in a travelling direction D and comprises a frame 2; a pair of motorized tracks 3 (only one of which is visible in FIG. 1); a detection device 4, 5 configured to detect data indicative of an environment surrounding the crawler vehicle 1; and a control system 6 in communication with the detection device 4, 5.

In certain embodiments, the control system 6 is provided with wireless connection capability (e.g., directly through a local communication network or through a mobile data network and an Internet connection) for connection to a remote monitoring system 39 of a ski resort. In more detail, the remote monitoring system 39 is configured to receive data from the control unit 6, to process the received data, and to monitor and/or control a fleet of crawler vehicles 1 based on or as a function of the processed data. In accordance with certain embodiments, the remote monitoring system 39 implements one or more artificial intelligence algorithms.

The crawler vehicle 1 of certain embodiments additionally comprises a pair of drive wheels 7 (only one of which is visible in FIG. 1), each of which is coupled to a respective track 3; a propulsion system 8 (e.g., internal combustion or electric or hydrogen-powered) configured to transmit power to the drive wheels 7; and a working tool assembly 9 connected to the frame 2.

In a non-limiting embodiment of the present disclosure, the working tool assembly 9 comprises a tiller 10, a shovel 11, and a winch 12. It is understood that the crawler vehicle 1 does not necessarily include all the working tools 9 mentioned above. For example, the crawler vehicle 1 may comprise any one or two of the working tools 9 selected from the tiller 10, the shovel 11 and the winch 12.

In a non-limiting embodiment of the present disclosure, the crawler vehicle 1 comprises a cab 13 mounted on the frame 2 and a user interface 14, which is arranged in the cab 13 and is provided with an interface screen 15. In accordance with certain embodiments (not shown in the figures), the user interface 14 comprises a plurality of interface screens 15.

In accordance with certain alternative embodiments (not shown in the figures), the crawler vehicle 1 is without a cab and the user interface 14 is arranged at a remote location.

In various embodiments, one or more or each detection device 4, 5 comprises one or more of a lidar, a radar, an infrared video camera, a stereoscopic camera, a camera and/or a video camera such as at 270° or 360°. By way of example, in the event that the detection device 4, 5 comprises a camera or a video camera, the detection device 4, 5 is configured to respectively detect images or videos of the environment surrounding the crawler vehicle 1.

In accordance with variant embodiments of the present disclosure, one or more or each detection device 4, 5 comprises a thermographic camera configured to acquire thermographic images and/or thermographic videos of the environment surrounding the crawler vehicle 1. In certain embodiments, one or more or each detection device 4, 5 comprising a thermographic camera that enables one or more of the following to be detected: snow temperature(s); snow humidity; air temperature(s); air humidity; snowpack profile (i.e., based on the temperature difference between snowpack M and air); distinguishing a worked surface of snowpack M from an unworked surface of snowpack M. The use of the thermographic camera is particularly useful in conditions of relatively poor visibility, such as at night or in foggy conditions.

In more detail, the detection device 4 of certain embodiments is arranged in a front portion of the crawler vehicle 1, is facing in the travelling direction D, and is configured to detect data indicative of the environment surrounding the crawler vehicle 1 in the travelling direction D.

The detection device 5 of certain embodiments is arranged in a rear portion of the crawler vehicle 1, is facing in a direction substantially opposite to the traveling direction D, and is configured to detect data indicative of the environment surrounding the crawler vehicle 1 from the rear portion of the crawler vehicle 1.

In a non-limiting embodiment of the present disclosure, the acquisition device 5 is mounted on a rear portion of the crawler vehicle 1, in a retracted position with respect to one or more of the direction of travel, the drive wheels 7 and/or the winch 12, and is configured to acquire videos and/or images of a portion of the snowpack M, already processed in certain instances, to the rear of the tiller 10.

In accordance with certain embodiments of the present disclosure (not shown in the figures), the acquisition device 5 is attached to the tiller 10.

In accordance with certain embodiments of the present disclosure (not shown in the figures), one or more or each detection device 4, 5 can be mounted on the shovel 11 or on the winch 12 or along a ski run or on an aerial vehicle, unmanned in certain instances, such as for example an aerial drone.

In certain additional embodiments, the crawler vehicle 1 of certain embodiments may comprise further detection devices (not shown in the figures) arranged, for example, along lateral portions of the crawler vehicle 1 to detect data indicative of the environment surrounding the crawler vehicle 1 in directions transverse to the travelling direction D.

In certain addition embodiments, the crawler vehicle 1 comprises a sensor assembly 16 which is in communication with the control system 6 and is configured to detect operative information comprising one or more of operational parameters of the crawler vehicle 1, information about the operations to be performed and/or information about the characteristics of the environment surrounding the crawler vehicle 1.

In certain embodiments, the sensor assembly 16 comprises a satellite navigation device (e.g., a Global Navigation Satellite System (“GNSS”) type device) which is configured to detect the position and the three-dimensional orientation of the crawler vehicle 1.

In accordance with certain embodiments (not shown in the figures), the sensor assembly 16 can be arranged aboard further crawler vehicles or aboard an aerial vehicle, unmanned in certain instances, such as an aerial drone.

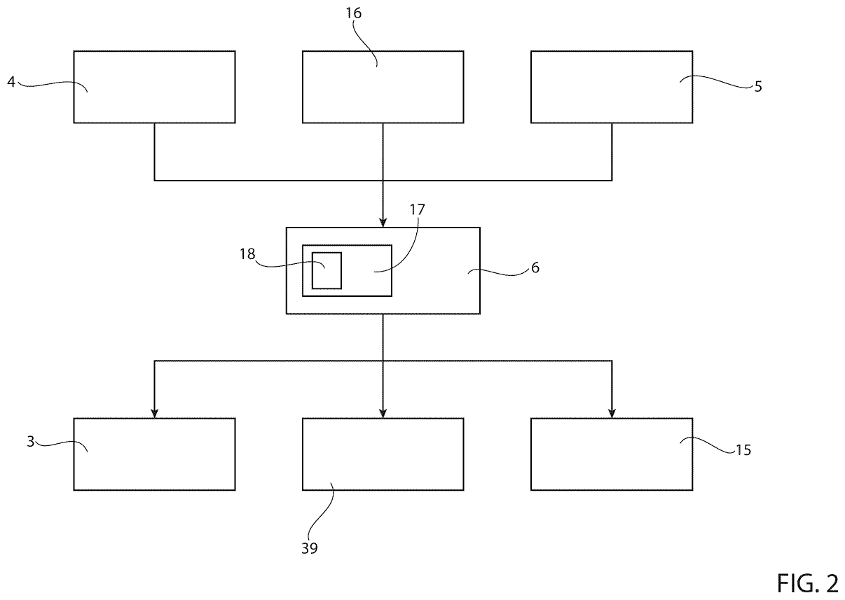

With reference to FIG. 2, the control system 6 of certain embodiments comprises a processing module 17 configured to process the data detected by the detection device 4, 5 and to identify a position and/or a conformation of reference elements in the environment surrounding the crawler vehicle 1 based on or as a function of the processed data.

In certain embodiments, the processing module 17 is configured to identify a position of objects and/or living beings in the environment surrounding the crawler vehicle 1 based on or as a function of the processed data and/or to determine a conformation of the environment surrounding the crawler vehicle 1 based on or as a function of the processed data.

Furthermore, in certain embodiments, the control system 6 is configured to receive from the sensor assembly 16 operative information comprising one or more of operational parameters of the crawler vehicle 1, information about the operations to be performed and/or information about the characteristics of the environment surrounding the crawler vehicle 1. The processing module 17 is configured to process the information received from the sensor assembly 16 and to identify the position and/or conformation of the reference elements in the environment surrounding the crawler vehicle 1 also based on or as a function of the information.

In various embodiments, the control system 6 is configured to perform at least one of the following actions: sending to the interface screen 15 information indicative of the identified position and/or the identified conformation of the reference elements to enable a display of the information on the interface screen 15; sending to the remote monitoring system 39 information indicative of the identified position and/or the identified conformation of the reference elements; controlling the advancement of the crawler vehicle 1 in the surrounding environment based on or as a function of the identified position and/or the identified conformation of the reference elements; interrupting the advancement of the crawler vehicle 1 in the surrounding environment based on or as a function of the identified position and/or the identified conformation of the reference elements.

In certain embodiments, the control system 6 is configured to independently control the tracks 3 to advance the crawler vehicle 1 based on or as a function of the identified position and/or the identified conformation of the reference elements. In more detail, the control system 6 is configured to control the propulsion system 8 to operate the tracks 3 based on or as a function of the identified position and/or the identified conformation of the reference elements.

In the case described and shown, the processing module 17 comprises a memory 18 in which a database containing comparison images of a plurality of reference elements of different types is stored. The processing module 17 is configured to classify each reference element based on or as a function of the processed data and the comparison images stored in the database. By way of example, the processing module 17 is configured to classify each reference element as an obstacle or as a boundary element delimiting an area that can be travelled by the crawler vehicle 1 or as a component of the crawler vehicle, for example the tiller 10 or the shovel 11 or the winch 12. In more detail, the processing module 17 comprises artificial intelligence algorithms, which, in certain instances, employ pre-trained convolutional neural networks configured to detect and classify the reference elements. In accordance with a non-limiting embodiment of the present disclosure, the artificial intelligence algorithms comprise object detection models, such as the “YOLO—(You Only Look Once)” model.

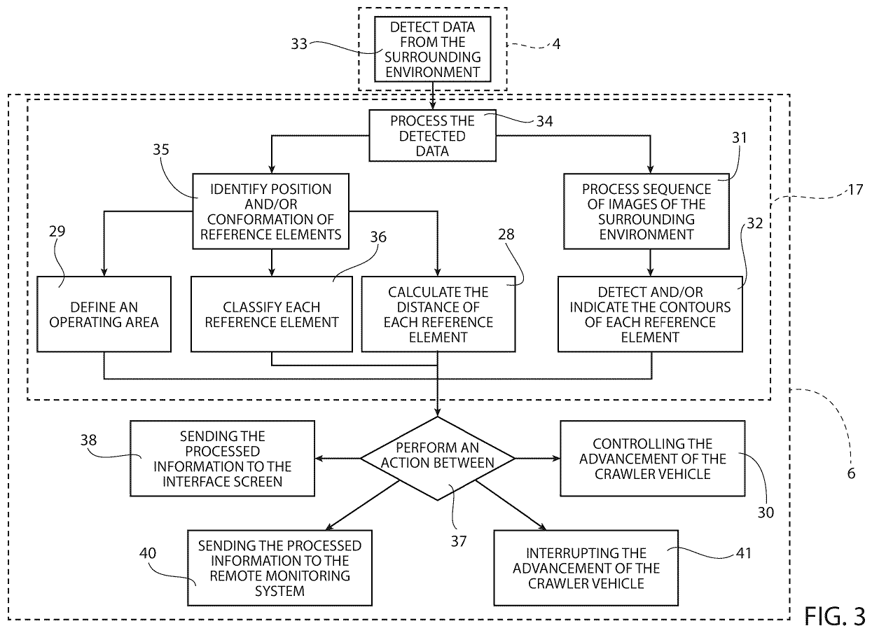

With reference to FIG. 3, the processing module 17 of certain embodiments is configured to calculate a distance of each identified reference element from the crawler vehicle 1 based on or as a function of the processed data (block 28). By way of example, the processing module 17 implements a “Monocular Depth Estimation” algorithm, which is configured to estimate the distance of reference elements by receiving images and/or videos detected by a single camera as input.

In addition, the processing module 17 of certain embodiments is configured to define an area that can be travelled by the crawler vehicle 1 based on or as a function of the identified position and/or the identified conformation of the reference elements (block 29) and to plan an optimal advancement path within the area that can be travelled by the crawler vehicle 1, so as to avoid collisions with any reference elements classified as obstacles. In certain embodiments, the control system 6 is configured to control the motorised tracks 3 so as to advance the crawler vehicle 1 in the defined operating area, along the planned optimal travel path (block 30).

Furthermore, the processing module 17 of certain embodiments is configured to process in real time a sequence of digital images of the environment surrounding the crawler vehicle 1 based on or as a function of the data detected by the detection device 4, 5 (block 31). In certain embodiments, the processing module 17 is configured to detect and/or indicate contours of each reference element in the sequence of processed digital images (block 32). In more detail, the artificial intelligence algorithms implemented by the processing module 17 comprise deep learning models, such as a “Semantic Segmentation” model, which associate a category with each unitary element, such as each pixel, of the digital image processed to group similar unitary elements in the same category.

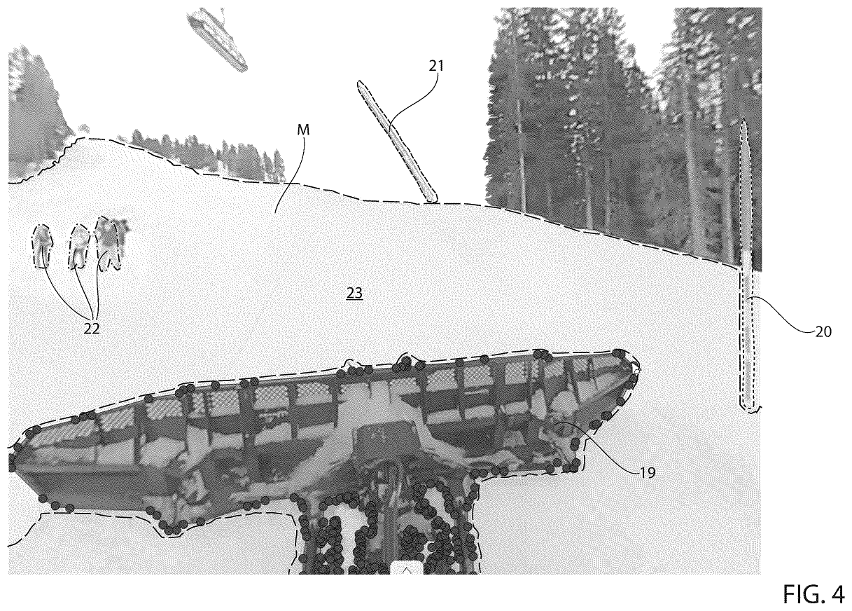

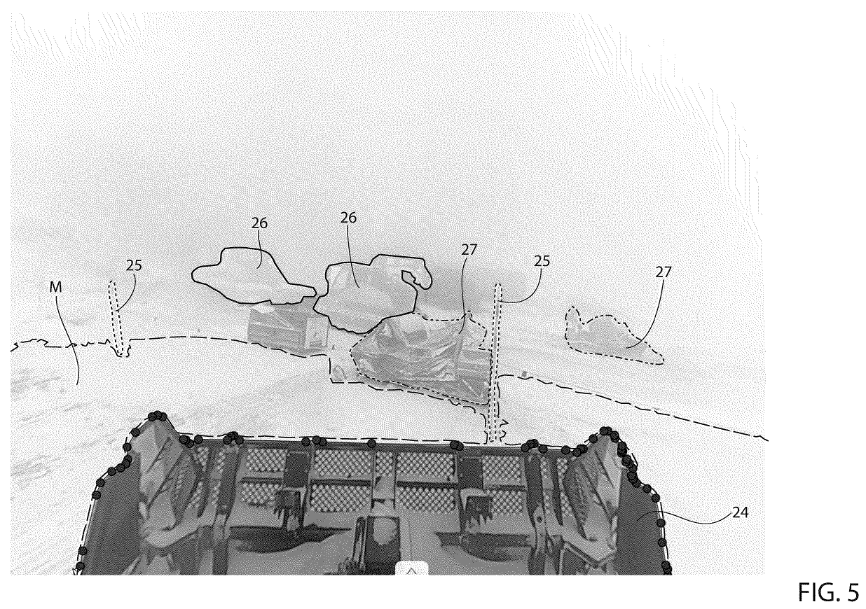

With reference to FIGS. 4 and 5, respective examples of digital images processed by the processing module 17 are shown.

With reference to FIG. 4, the reference module 17 of certain embodiments processes the digital image of the environment surrounding the crawler vehicle 1 and detects and identifies the contours of each reference element 19, 20, 21, 22 and the area occupied by each reference element 19, 20, 21, 22. In certain embodiments, the processing module 17, by employing the comparison images stored in the memory 18 (FIG. 2) and implementing artificial intelligence algorithms, classifies the reference element 19 as a shovel of the crawler vehicle 1, the reference element 20 as a pole, the reference element 21 as a snow lance, and the reference elements 22 as people.

Furthermore, the processing module 17 of certain embodiments defines the area that can be travelled 23 by the crawler vehicle 1 as a portion of snowpack M in which the areas occupied by the reference elements 20, 21, 22 are excluded.

With reference to FIG. 5, the reference module 17 of certain embodiments processes the digital image of the environment surrounding the crawler vehicle 1 and detects and identifies the contours of each reference element 24, 25, 26, 27 and the area occupied by each reference element 24, 25, 26, 27. In certain embodiments, the processing module 17 classifies the reference element 24 as a shovel of the crawler vehicle 1, the reference elements 25 as poles, the reference elements 26 as crawler vehicles, and the reference elements 27 as snowmobiles.

In use and with reference to FIG. 3, the detection devices 4 and 5 of certain embodiments detect data indicative of the environment surrounding the crawler vehicle 1 (block 33) and transmit the detected data to the control system 6.

The control system 6 of certain embodiments receives the data detected by the detection devices 4, 5 and the processing module 17 processes the received data in real time (block 34). In certain embodiments, the processing module 17 processes in real time a sequence of digital images of the environment surrounding the crawler vehicle 1 based on or as a function of the data detected by the detection device 4, 5 (block 31). In more detail, the processing module 17 detects and/or indicates the contours of each reference element in the sequence of digital images processed by implementing intelligence algorithms including deep learning models (block 32).

In certain addition or alternative embodiments, the processing module 17 identifies a position and/or a conformation of the reference elements in the environment surrounding the crawler vehicle 1 based on or as a function of the processed data (block 35). In more detail, the processing module 17 classifies each reference element based on or as a function of the processed data and comparison images stored in the database and by implementing artificial intelligence algorithms (block 36).

Furthermore, the processing module 17 of certain embodiments calculates a distance of each reference element identified by the crawler vehicle 1 based on or as a function of the identified position of the reference elements (block 28) and/or, in accordance with certain variant embodiments of the present disclosure (not shown in the figures), based on or as a function of the sequence of processed images of the surrounding environment.

In certain additional embodiments, the processing module 17 of certain embodiments defines an area that can be travelled by the crawler vehicle 1 based on or as a function of the identified position and/or the identified conformation of the reference elements (block 29) and/or, in accordance with certain variant embodiments of the present disclosure (not shown in the figures), based on or as a function of the detected contours of each reference element.

In accordance with one form of implementation, the processing module 17 of certain embodiments autonomously plans an optimal advancement path for the crawler vehicle 1 within the defined operating area so as to avoid collisions with any reference elements classified as obstacles.

At this point, the control system 6 performs at least one of the following actions (block 37):
sends to the interface screen 15 information indicative of the identified position and/or the identified conformation of the reference elements, such as the processed digital images and/or video in real time and/or a schematic representation through icons, to enable a display of the information on the interface screen 15 (block 38), and/or audible alarms for reference elements at a distance less than a predefined distance;
sends to the remote monitoring system 39 information indicative of the identified position and/or the identified conformation of the reference elements (block 40);
controls the advancement of the crawler vehicle 1 in the surrounding environment based on or as a function of the identified position and/or identified conformation of the reference elements identified (block 30); and/or
interrupts the advancement of the crawler vehicle 1 in the surrounding environment based on or as a function of the identified position and/or the identified conformation of the reference elements (block 41).

In certain embodiments, depending on the actions performed by the control system 6, the crawler vehicle 1 can be used in one or more of the following operating modes: a first fully autonomous operating mode, in which the control system 6 plans the optimal advancement path and controls the crawler vehicle 1 so that the crawler vehicle follows the optimal advancement path; and a second partially assisted operating mode, in which the advancement of the crawler vehicle 1 is controlled by a driver assisted by the information indicative of the position and/or conformation of the reference elements displayed on the interface screen 15.

It is evident that variants can be made to the present disclosure without, however, departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention is claimed as follows:

1. A crawler vehicle configured to advance in an operational environment and comprising:
a frame;
a pair of motorized tracks;
a detection device configured to detect data indicative of an environment surrounding the crawler vehicle; and
a control system in communication with the detection device and comprising a processing module configured to process the data detected by the detection device and identify at least one of a position and a conformation of reference elements in the environment surrounding the crawler vehicle based on the processed data, wherein the control system is configured to perform at least one of: sending to an interface screen information indicative of the at least one of the position and the conformation of the reference elements to enable a display of the information on the interface screen, sending to a remote monitoring system information indicative of the at least one of the position and the conformation of the reference elements, controlling an advancement of the crawler vehicle based on the at least one of the position and the conformation of the reference elements, and interrupting the advancement of the crawler vehicle based on the at least one of the position and the conformation of the reference elements.

2. The crawler vehicle of claim 1, wherein the detection device comprises at least one of a lidar, a radar, an infrared camera, a stereo camera, a camera and a video camera.

3. The crawler vehicle of claim 1, wherein the detection device faces in a travelling direction of the crawler vehicle and is configured to detect data indicative of the environment surrounding the crawler vehicle in the travelling direction.

4. The crawler vehicle of claim 1, wherein the detection device faces in a direction opposite to a travelling direction and is configured to detect data indicative of the environment surrounding the crawler vehicle in the direction opposite to the travelling direction.

5. The crawler vehicle of claim 1, wherein the processing module is configured to, at least one of:
identify a position of at least one of an object and a living being in the environment surrounding the crawler vehicle based on the processed data, and
determine a conformation of the environment surrounding the crawler vehicle based on the processed data.

6. The crawler vehicle of claim 1, wherein the processing module is configured to process, in real time and based on the data detected by the detection device, a sequence of digital images of the environment surrounding the crawler vehicle.

7. The crawler vehicle of claim 6, wherein the processing module is configured to, at least one of, detect and indicate contours of each reference element in the sequence of processed digital images.

8. The crawler vehicle of claim 1, wherein the processing module comprises a memory in which a database containing comparison images of a plurality of reference elements of different types is stored and the processing module is configured to classify each reference element based on the processed data and the comparison images stored in the database.

9. The crawler vehicle of claim 1, wherein the processing module is configured to calculate a distance of each identified reference element from the crawler vehicle based on the processed data.

10. The crawler vehicle of claim 1, wherein the processing module is configured to define an operating area travelable by the crawler vehicle based on the at least one of the position and the conformation of the reference elements.

11. The crawler vehicle of claim 10, wherein the control system is configured to control the motorized tracks to advance the crawler vehicle within the defined operating area.

12. The crawler vehicle of claim 1, wherein the processing module comprises an artificial intelligence algorithm.

13. The crawler vehicle of claim 1, further comprising a cab mounted on the frame and a user interface arranged in the cab, wherein the interface screen is configured to receive and display information indicative of the at least one of the position and the conformation of the reference elements.

14. A method of controlling a crawler vehicle, the method comprising:
detecting data indicative of an environment surrounding the crawler vehicle;
processing the detected data to identify, based on the processed data, at least one of a position and a conformation of reference elements in the environment surrounding the crawler vehicle; and
performing at least one of:
sending to an interface screen information indicative of the at least one of the position and the conformation of the reference elements to enable a display of the information on the interface screen,
sending to a remote monitoring system information indicative of the at least one of the position and the conformation of the reference elements,
controlling an advancement of the crawler vehicle based on the at least one of the position and the conformation of the reference elements, and
interrupting the advancement of the crawler vehicle based on the at least one of the position and the conformation of the reference elements.

15. The method of claim 14, further comprising processing, in real time and based on the detected data, a sequence of digital images of the environment surrounding the crawler vehicle.

16. The method of claim 14, further comprising classifying each reference element based on the processed data and comparison images of a plurality of reference elements of different types stored in a database.

17. The method of claim 14, further comprising calculating a distance of each identified reference element from the crawler vehicle based on the processed data.

18. The method of claim 14, further comprising defining an operating area travelable by the crawler vehicle based on the at least one of the position and the conformation of the reference elements.

19. A non-transitory computer-readable medium that stores a plurality of instructions that, when executed by a control system of a crawler vehicle, cause the control system to:
detect data indicative of an environment surrounding the crawler vehicle;
process the detected data to identify, based on the processed data, at least one of a position and a conformation of reference elements in the environment surrounding the crawler vehicle; and
perform at least one of:
sending to an interface screen information indicative of the at least one of the position and the conformation of the reference elements to enable a display of the information on the interface screen,
sending to a remote monitoring system information indicative of the at least one of the position and the conformation of the reference elements,
controlling an advancement of the crawler vehicle based on the at least one of the position and the conformation of the reference elements, and
interrupting the advancement of the crawler vehicle based on the at least one of the position and the conformation of the reference elements.
